(19) United States
(12) Patent Application Publication
(10) Pub. No.: US 2025/0244271 A1
(43) Pub. Date: Jul. 31, 2025

(54) DEVICE AND METHOD FOR DETERMINING A DENSITY OF A RADICAL IN A GAS

(71) Applicant: INFICON AG, Balzers (LI)

(72) Inventors: Bernhard ANDREAUS, Rapperswil (CH); Oskar UNTERMARZONER, Ruggell (LI); Urs WÄLCHLI, Chur (CH); Stefan KAISER, Ruggell (LI); Martin WÜEST, Malans (CH)

(21) Appl. No.: 18/854,628

(22) PCT Filed: Mar. 13, 2023
(86) PCT No.: PCT/EP2023/056339

§ 371 Date: Oct. 7, 2024

(30) Foreign Application Priority Data
Apr. 8, 2022 (CH) CH000395/2022

(51) Int. Cl. G01N 25/32; G01N 31/10

(52) U.S. Cl. CPC G01N 25/32; G01N 31/10

(57) ABSTRACT

A device (10) for determining a density of radicals (5) of a radical type in a measuring space (4) comprises
a catalyst material (1) which can be brought into contact with the measuring space at least in the region of a first surface (15) of the catalyst material, wherein the catalyst material is suitable for triggering an exothermic recombination reaction of radicals of the radical type when radicals of the radical type come into contact with the first surface;
a temperature actuator (2) in thermal contact with the first surface; and
a temperature sensor (3) in thermal contact with the first surface.

The device is designed to control the temperature actuator by means of a control signal in such a way that the measured value detected by the temperature sensor is kept at a setpoint value, and wherein the control signal can be evaluated in order to determine the density of radicals of the radical type in the measuring space.

The invention is further directed to a method for determining a density of radicals (5) of one radical type in a measuring space.

The present invention relates to a device for determining a density of radicals in a measurement volume.

A well-known approach to determine the density of radicals is measurement by optical methods (e.g., H.-P. Dorn et al, Atmos. Meas. Tech., 6, 1111-1140, 2013). An alternative approach is based on the measurement of a temperature rise of a catalyst on whose surface recombination energy is released by a radical recombination reaction. For the latter approach, the temperature rise is related to the density of the radicals, so that an inference thereto can be made to some extent. This technique was used by W. V. Smith as early as 1943 to measure H and OH radicals (J. Chem. Phys 11, 110f, 1954). For 0-radicals, for example, Linnett and Greaves (J. W. Linnett and D. G. H. Marsden, Proc. R. Soc. Lond. A 234, 504-515, 1956; J. C. Greaves and J. W. Linnett, Trans. Faraday Soc., 54, 1323-1330, 1958) used this measurement methodology. Haraki et al. have refined this general technique as a sensor element for 0 radicals by compensating for general gas temperature effects with a reference element that is insensitive to the radicals being measured. In addition, they can quantitatively determine radical densities with their sensor (N. Haraki et al, Electrical Engineering in Japan 149 (4), 1075-1080, 2004). Thus, in the prior art, temperature change is measured as a measure of radical concentration. These temperature changes can be as high as over 1000° C., as reported in Haraki et al.

However, a measurement method based on a change in temperature has some disadvantages for radical concentration measurement.

First, the quantitative measurement of concentration is complicated by the fact that the recombination rate constant is itself a function of temperature (Fryberg et al., J. Chem. Phys. 32, 622-623, 1960). Furthermore, different reactions and reaction mechanisms of the total potential reactants present in the measuring space may also occur at different temperatures. Then, significant temperature changes can alter the mechanical as well as chemical properties of the catalyst as well as the entire sensor assembly, especially weakening, deforming, or aging, for example, due to multiple temperature cycles. Finally, it is possible that during heating of the catalyst element, existing adsorbates, which limited the number of catalyst sites, desorb and thus additional catalyst area is gained during hot operation. This makes quantitative estimation very difficult for dynamic processes.

It was the object of the present invention to provide a device or method which reduces or eliminates at least one disadvantage of the prior art. In particular, the object was to determine more precisely the density of radicals in a measuring space.

This object is solved by a device according to claim 1 or by a method according to claim 10.

The device according to the invention is a device for determining a density of radicals of a radical type in a measuring space. The device comprises:
a catalyst material which can be brought into contact with the measuring space at least in the region of a first surface of the catalyst material, wherein the catalyst material is suitable for triggering an exothermic recombination reaction of radicals of the radical type when radicals of the radical type come into contact with the first surface,
a temperature actuator in thermal contact with the first surface, and
a temperature sensor in thermal contact with the first surface.

The device is designed to control the temperature actuator by means of a control signal in such a way that the measured value detected by the temperature sensor is maintained at a setpoint value. The control signal can be evaluated to determine the density of radicals of the radical type in the measuring space.

The inventors have recognized that disadvantages of the prior art can be avoided in a surprisingly simple manner by keeping a catalyst element, i.e. specifically the above-mentioned first surface of the device according to the invention, at a constant temperature. In this way, the temperature dependence of the recombination rate constant does not come into play and also the number of available catalyst sites is not varied by a temperature-dependent adsorption and desorption of further substance. Nevertheless, the device according to the invention allows the determination of the power delivered by the recombination reaction of radicals of the radical type on the catalyst surface, namely by evaluating the control signal to the temperature actuator. For example, the power delivered to the temperature actuator can be monitored. If more power is needed to keep the temperature constant, this increase may just correspond to a power falling away due to the recombination reaction, which in turn corresponds to a decreasing density of radicals in the measuring space. Conversely, an increasing density of radicals in the measuring space leads to an increase in the power delivered to the catalyst surface by the recombination reaction, so that less power needs to be delivered to the temperature actuator to keep the temperature constant.

The temperature actuator may be configured to heat the first surface, to cool the first surface, or to heat and cool the first surface. For example, the temperature actuator may be an electrically operated temperature actuator, such as a resistance heater or a Peltier element. In an alternative, the temperature actuator may be a heat exchanger element through which a cooling or heating medium may flow, for stabilizing the temperature of the first surface. The temperature actuator is thus an actuator for adjusting the temperature of the first surface.

The radical type can be, for example, oxygen radicals, which react in a recombination reaction to form oxygen molecules. Catalyst materials which promote this recombination reaction to oxygen molecules are, for example, salts such as potassium chloride or lithium chloride, especially at high temperatures, metals (e.g. Co, Ag, Cu, Pt) and metal oxides (e.g. PbO or MoO3) already at low temperatures. It is quite possible to have radicals of several chemical species reacting in the measuring space. In this case we understand radical type as a generic term, which includes radicals of several chemical species. If the catalyst material is a selective catalyst material, which does not allow a part of the radicals present to react, this non-reacting part does not belong to the radical type.

The measuring space can be, for example, a space filled with gas, or a largely evacuated space, in the latter case measuring the density of radicals in a residual gas. The measuring space may be a closed volume or a space which, depending on the application, may be in open fluid communication with a process space, with an exhaust gas stream, with ambient air, etc.

In one embodiment of the device, the temperature actuator is an electrically heatable resistive element. The control signal is adapted to control an electrical current through the temperature actuator. For example, the control signal may be a digital signal for controlling a current source. The control signal can, for example, be a voltage which is applied directly to the resistive element.

In one embodiment of the device, the temperature sensor is formed by a temperature-dependent electrical resistive element or by a thermocouple. The temperature sensor can, for example, be designed as a resistance thermometer (RTD), e.g. in the form of a platinum measuring resistor with 100 ohms at 0° C. (Pt100).

In one embodiment of the device, which combines previously mentioned embodiments, an electrically conductive wire with a temperature-dependent electrical resistance forms both the temperature actuator and the temperature sensor. In this case, the electrically conductive wire can be coated with the catalyst material, or alternatively, consist entirely of the catalyst material. The outer surface of the catalyst material forms the first surface on which the recombination reaction of the radicals can take place.

In one embodiment of the device, which comprises an electrically conductive wire as a combined temperature actuator and temperature sensor, the electrically conductive wire has a diameter in the range 5-50 microns.

The inventors realized that this results in a surface to mass ratio of the wire that allows sensitive measurement of relatively low radical densities with a short response time. Even a small amount of energy applied to the surface of the wire results in a measurable change in the temperature of the wire. The relatively low mass ensures low thermal inertia.

In one embodiment of the device, the electrically conductive wire has a coiled shape. This offers advantages in mechanical stability against shocks and vibrations and allows a more compact design with the same sensitivity compared to an unbent or straight wire.

In one embodiment, the device further comprises a reference pressure sensor. The reference pressure sensor is designed to detect the pressure in the measuring space. The reference pressure sensor can be brought into contact with the measuring space in the region of a second surface. The reference pressure sensor uses a pressure measurement principle that operates substantially unaffected by a density of radicals of the radical type.

The inventors have recognized that by considering the pressure in the measuring space, the accuracy of the determination of the density of radicals can be further increased. In particular, the pressure in the measuring space can affect the power flowing from the first surface into the environment via the thermal conductivity of a gas in the measuring space, and thus, complicate the interpretation of the power balance. If the effective pressure is known, such an effect can be corrected. The reference pressure sensor can, for example, be constructed as a membrane pressure sensor.

In one embodiment of the device, the reference pressure sensor is a heat conduction vacuum gauge having a sensing wire, wherein the reference pressure sensor is adapted to determine a pressure-dependent heat output of the sensing wire, and wherein the wire is free of catalyst material.

In this embodiment, the reference pressure sensor is thus a vacuum gauge according to Pirani. In particular, a variant of this embodiment is conceivable in which the reference pressure sensor and the part of the device sensitive to the recombination reaction of radicals are constructed largely identically, except for the difference that the latter part has a surface of catalyst material, while the Pirani sensor is free of catalyst material. In this constellation, the Pirani sensor is equally sensitive to all perturbations as the part of the device sensitive to the recombination reaction of radicals, so that the difference between the two sensor elements is particularly sensitive to the density of radicals.

In one embodiment of the device, the device further comprises a reference temperature sensor. The reference temperature sensor is designed to detect the temperature in the measuring space. The reference temperature sensor can be brought into contact with the measuring space in the region of a third surface, wherein the third surface is substantially free of the catalyst material.

The inventors have recognized that temperature changes in the environment of the device can interfere with the measurement of the density of the radicals. By means of the reference temperature sensor, e.g., pre-calibrated interference effects can be extracted from the signal. It is important in this context that the reference temperature sensor is as unaffected as possible by recombination reactions of radicals of the radical type to be measured. This is achieved by ensuring that the third surface, with which the reference temperature sensor comes into contact with the measuring space and thus with the radicals when the measurement is carried out, does not comprise any catalyst material.

Further, the present invention is directed to a method according to claim 10.

The method according to the invention is used to determine a density of radicals of one radical type in a measuring space. The method comprises the steps of:
bringing a first surface of a catalyst material into contact with a gas in the measuring space, wherein the catalyst material is suitable for triggering an exothermic recombination reaction of the radical when the radical comes into contact with the first surface,
keeping the temperature of the first surface constant at a target temperature, wherein said keeping constant is performed by means of a control loop comprising a temperature actuator in thermal contact with the first surface and a temperature sensor in thermal contact with the first surface,
evaluating a control signal of the control loop to the temperature actuator for determining the density of the radical in the measuring space.

The inventors have recognized that by keeping the temperature of the catalyst surface constant, disadvantages of the prior art are eliminated in a simple manner. Instead of the temperature increase of the catalyst being observed and evaluated, according to the invention, the control signal which controls the temperature actuator just so that the temperature of the first surface remains constant is used as a quantity from which the density of radicals of the radical type is determined.

In one variant of the method, the temperature actuator is a heating element. In this case, the target temperature is higher than a temperature that is established at the first surface solely due to the heating power caused by the recombination reaction of the radical.

In this variant, the control loop delivers the maximum heating power to the first surface when no radicals are present. As soon as a recombination reaction of radicals heats the surface, the supplied heating power is reduced so that the temperature remains constant. Ideally, at an expected density of radicals, the required supplied heating power is still slightly positive.

In a variant of the method, the device according to the invention is used according to one of the claims. In particular, the method according to the invention may be an operating method for the device according to the invention.

Exemplary embodiments of the present invention are explained in further detail below with reference to figures, wherein:

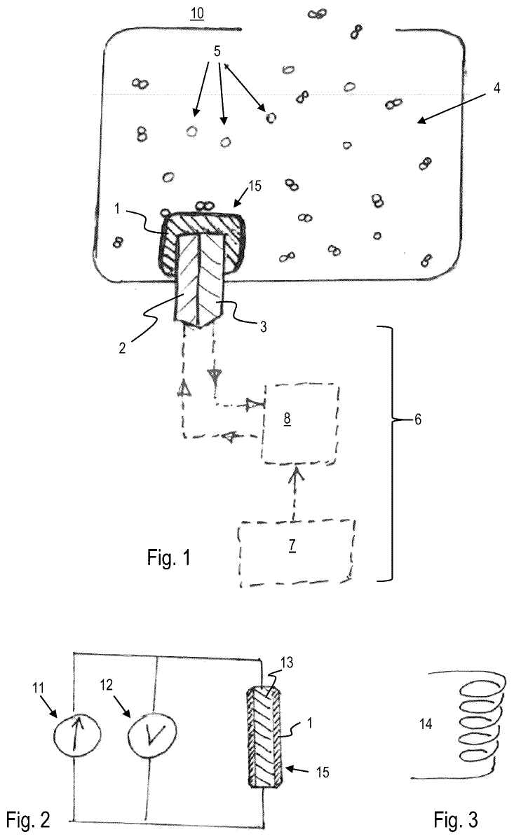

FIG. 1 shows a schematic representation of an embodiment of the device;

FIG. 2 shows a schematic representation of part of an embodiment;

FIG. 3 shows a perspective view of a wire for one embodiment;

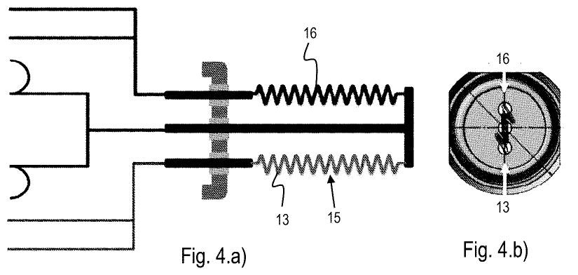

FIG. 4 shows in partial figures FIG. 4.a) and FIG. 4.b) an arrangement of resistance wires for one embodiment of the device, in side view (FIG. 4.a) and in top view (FIG. 4.b).

In FIG. 1, a measuring space 4 is shown in the upper section as a schematic cross-sectional drawing, in this case in open fluid-dynamic communication with an environment. Schematically shown as small circles are radicals 5, which can react in a recombination reaction to form molecules, which are schematically shown as small double circles. The device according to one embodiment is shown in measuring position. A catalyst material 1 of the device has a first surface 15 which is in contact with the measuring space 4. Radicals 5 can react on the first surface in a recombination reaction. This reaction is promoted by the catalyst material. The first surface thereby absorbs a portion of the energy released in the reaction. The catalyst material is not consumed in the reaction. In thermal contact with the catalyst material is a temperature actuator 2 and a temperature sensor 3. The device is designed to control the temperature actuator by means of a control signal in such a way that the measured value detected by the temperature sensor is maintained at a setpoint value and wherein the control signal can be evaluated to determine the density of radicals of the radical type in the measuring space. A control circuit 6, which can perform the task of keeping the temperature constant, is shown schematically and in dashed lines. A control means 8 receives a temperature signal from the temperature sensor 3, compares it with a predetermined target temperature 7 and controls the temperature actuator 2 with a control signal in such a way that the temperature measured by the temperature sensor remains at the target temperature 7 or moves towards the target temperature if a deviation is measured. The control means can be, for example, a PID controller, but simpler or more complicated forms of control means can also perform the task of keeping the temperature constant. From the control signal to the temperature actuator, and the temporal change of the control signal respectively, information about the density of the radicals in the measuring space, and about the temporal change of the density of the radicals in the measuring space respectively, can be determined.

FIG. 2 shows an electrical circuit diagram of a partial embodiment of the device. In this embodiment, an electrically heatable resistive element 13 forms both the temperature actuator and the temperature sensor of the device. A power source 11 provides the current to heat the resistive element. The resistive element 13, shown here in cross-section, is coated with a catalyst material 1 which has a first surface 15 towards the outside on which a recombination reaction of radicals can take place. This reaction additionally leads to a heating of the resistive element 13. The resistive element has a temperature-dependent resistance. From the voltage measured by the voltmeter 12, which drops at the current supplied by the current source 11, the instantaneous resistance and thus the temperature of the resistive element 13 can be determined. If the temperature drops, the current and thus the electrical power supplied is increased until the target temperature is reached again. If the temperature rises above the setpoint, the current is reduced accordingly. The applied current, or a control signal that specifies this current, can be evaluated as an indicator for the density of the radicals of the type to be measured. Such a control loop can be easily realized, for example, by a bridge circuit (Wheatstone's bridge circuit).

FIG. 3 schematically shows a wire 14 in coiled form as it can be used as an electrical resistive element in one embodiment of the device as a temperature actuator and temperature sensor in one, wherein the coiled wire is coated with catalyst material or consists of the catalyst material.

FIG. 4 shows in partial FIG. 4.a) a schematic side view of two coiled resistance wires with electrical connections, which are passed through a bushing shown as a cross-section in an insulated manner. On the left of the figure, a connection diagram for a connection to current sources and voltage measuring device is shown schematically. The resistive element 13 shown in FIG. 4.a) below has the role of temperature sensor and temperature actuator of the device. It is coated with a catalyst material (symbolized here with gray hatching), which forms the first surface 15. A reference pressure sensor 16 is formed by the second resistance wire, also in coiled form (shown here in black). In this embodiment, the reference pressure sensor is formed as a Pirani sensor. Resistive element 13 and reference pressure sensor can thus be formed with the same geometry and material in the resistance wire, the only difference being that one of the wires is coated with catalyst material and the other is not. The material of the resistance wires can be platinum, for example. A common ground connection (center feedthrough) for both resistance wires is provided. This has the advantage that ions in the measuring space are minimally disturbed by the arrangement when current flows through the resistance wires during operation. The feedthrough can be designed to be vacuum-tight, for example. During operation, the area to the right of the feedthrough protrudes into the measuring space.

FIG. 4.b) shows the top view of the arrangement from the side of the resistive element 13 and the reference pressure sensor 16.

### LIST OF REFERENCE SIGNS

1 Catalyst material
2 Temperature actuator
3 Temperature sensor
4 Measuring space
5 Radical(s) (of one type of radical)
6 Control circuit
7 Target temperature
8 Control means
10 Device
11 Current source
12 Voltage measuring device
13 Resistive element, electrically heatable
14 Wire in coiled form
15 First surface
16 Reference pressure sensor

1. Device (10) for determining a density of radicals (5) of a radical type in a measuring space (4), wherein the device comprises:
a catalyst material (1) which can be brought into contact with the measuring space at least in the region of a first surface (15) of the catalyst material, wherein the catalyst material is suitable for triggering an exothermic recombination reaction of radicals of the radical type when radicals of the radical type come into contact with the first surface,
a temperature actuator (2) in thermal contact with the first surface, and
a temperature sensor (3) in thermal contact with the first surface,
wherein the device is designed to control the temperature actuator by means of a control signal in such a way that the measured value detected by the temperature sensor is kept at a setpoint value, and wherein the control signal can be evaluated in order to determine the density of radicals of the radical type in the measuring space.

2. Device (10) according to claim 1, wherein the temperature actuator (2) is an electrically heatable resistive element (13) and wherein the control signal is adapted to control an electrical current through the temperature actuator.

3. Device (10) according to claim 1, wherein the temperature sensor (3) is formed by a temperature-dependent electrical resistive element or by a thermocouple.

4. Device (10) according to claim 2, wherein an electrically conductive wire with a temperature-dependent electrical resistance forms both the temperature actuator (2) and the temperature sensor (3), and wherein the electrically conductive wire is coated with the catalyst material (1) or consists of the catalyst material (1).

5. Device (10) according to claim 4, wherein the electrically conductive wire has a diameter in the range 5-50 microns.

6. Device (10) according to claim 4, wherein the electrically conductive wire has a coiled shape (14).

7. Device (10) according to claim 1, wherein the device further comprises a reference pressure sensor adapted to sense the pressure in the measuring space, wherein the reference pressure sensor can be brought into contact with the measuring space in the region of a second surface, and wherein the reference pressure sensor uses a pressure measurement principle that operates substantially unaffected by a density of radicals of the radical type.

8. Device (10) according to claim 7, wherein the reference pressure sensor is a heat conduction vacuum gauge having a sensing wire, wherein the reference pressure sensor is adapted to determine a pressure-dependent heat output of the sensing wire, and wherein the wire is free of catalyst material.

9. Device (10) according to claim 1, wherein the device further comprises a reference temperature sensor (16) adapted to detect the temperature in the measuring space, wherein the reference temperature sensor is contactable with the measuring space in the region of a third surface, and wherein the third surface is substantially free of the catalyst material.

10. Method for determining a density of radicals (5) of a radical type in a measuring space (4), wherein the method comprises the steps of:
bringing a first surface (15) of a catalyst material into contact with a gas in the measuring space, wherein the catalyst material is suitable for triggering an exothermic recombination reaction of the radical when the radical comes into contact with the first surface,
keeping the temperature of the first surface constant at a target temperature (7), wherein the keeping constant is carried out by means of a control circuit comprising a temperature actuator in thermal contact with the first surface and a temperature sensor in thermal contact with the first surface,
evaluating a control signal of the control circuit to the temperature actuator for determining the density of the radical in the measuring space.

11. Method according to claim 10, wherein the temperature actuator (2) is a heating element, and wherein the target temperature (7) is higher than a temperature established at the first surface solely due to the heating power by the recombination reaction of the radical.

12. Method according to claim 10, wherein a device (10) for determining a density of radicals (5) of a radical type in a measuring space (4) comprises:
a catalyst material (1) which can be brought into contact with the measuring space at least in the region of a first surface (15) of the catalyst material, wherein the catalyst material is suitable for triggering an exothermic recombination reaction of radicals of the radical type when radicals of the radical type come into contact with the first surface,
a temperature actuator (2) in thermal contact with the first surface, and
a temperature sensor (3) in thermal contact with the first surface,
wherein the device is designed to control the temperature actuator by means of a control signal in such a way that the measured value detected by the temperature sensor is kept at a setpoint value, and wherein the control signal can be evaluated in order to determine the density of radicals of the radical type in the measuring space.
